(19) United States
(12) Patent Application Publication
(10) Pub. No.: US 2015/0136238 A1
(43) Pub. Date: May 21, 2015

(54) CONDUIT CONNECTION APPARATUS WITH PURGE GAS

(71) Applicant: Hatch Ltd., Mississauga (CA)

(72) Inventors: Michael Trovant, Toronto (CA); Mirza Ridwanul Haque, Mississauga (CA); Maher Al-Dojayli, Mississauga (CA); Predrag Jokovic, Toronto (CA); Hamidreza Ghorbani, Oakville (CA); Sandeep Suryakant Bhavsar, Mississauga (CA); Bosko Madic, Burlington (CA)

(73) Assignee: Hatch Ltd., Mississauga, ON (CA)

(21) Appl. No.: 14/391,923

(22) PCT Filed: Feb. 15, 2013
(86) PCT No.: PCT/CA2013/000132

§ 371 Date: Oct. 10, 2014

Related U.S. Application Data
(60) Provisional application No. 61/622,051, filed on Apr. 10, 2012.

(51) Int. Cl. F16L 23/18; B08B 9/032

(52) U.S. Cl. CPC F16L 23/18; B08B 9/0325
USPC 137/15.04; 137/240

(57) ABSTRACT

An apparatus connects first and second conduits that convey a flow of gas. The apparatus includes a first flange element fixed to the first conduit, and a second flange element fixed to the second conduit. The flange elements are coupled together to permit fluid communication in an internal environment between the first and second conduits. At least one port is intermediate the flange elements to deliver a flow of purge gas therebetween. The at least one port may be located within a purge gas channel arranged in one of the flange elements. A pressure gradient of the flow of purge gas may substantially prevent at least one of fluid egress from the internal environment and fluid ingress from an external environment. Purge gas distribution systems and related methods are also described.

### TECHNICAL FIELD

The present disclosure relates to sealing of conduits, such as pipe or duct connections, and to gas purging to establish a pressure gradient that prevents fluid egress and ingress.

### BACKGROUND

The following paragraphs are not an admission that anything discussed in them is prior art or part of the knowledge of persons skilled in the art.

Industrial processes involving gas flows may employ flange joints to connect individual pipe or duct segments. Flange joints may achieve a gas-tight seal by compressing a gasket between their mating surfaces, in order to fill any surface irregularities. In facilities involving flammable and/or poisonous process gases, preserving a gas-tight seal is important to avoid equipment damage and ensure safety.

For example, in a calcium carbide smelter, carbon monoxide off-gas may be ducted through a gas handling system for cooling, cleaning, and/or storage of the off-gas. Such a gas handling system may include numerous flange joints. It is important that out-leakage of poisonous off-gas from the gas handling system into the external working environment be avoided. Air infiltration into the ductwork of the gas handling system should also be avoided, in order to prevent development of an explosive gas mixture therein.

For flange joints with gaskets, the level of compression necessary to achieve a gas-tight seal (or “seating stress”) depends on the gasket type. In general, it may be difficult to achieve a gas-tight seal for flange joints in high temperature applications, as the gaskets and other flange components may be subject to wear and damage due to thermal expansion.

### SUMMARY OF THE DISCLOSURE

The following summary is intended to introduce the reader to the more detailed description that follows and not to define or limit the claimed subject matter.

According to an aspect of the present disclosure, an apparatus for connecting first and second conduits may include: a first flange element fixed to the first conduit; a second flange element fixed to the second conduit, the second flange element coupled to the first flange element to permit fluid communication in an internal environment between the first and second conduits; and at least one port that communicates intermediate the first and second flange elements to deliver a flow of purge gas therebetween.

A pressure gradient of the flow of purge gas may substantially prevent at least one of fluid egress from the internal environment and fluid ingress from an external environment.

The first flange element may include the at least one port for delivering the flow of purge gas. The apparatus may further include a purge gas channel arranged between mating surfaces of the first and second flange elements, and wherein the at least one port may communicate with the purge gas channel. The at least one port may extend from the purge gas channel through the first flange element and may fluidly communicates with at least one purge gas supply line. The at least one port may include a plurality of ports located spaced apart along the purge gas channel. The plurality of ports may include at least one port in fluid communication with a first purge gas supply line, and at least one port in fluid communication with a second purge gas supply line. The purge gas channel may be generally annular in shape, and may extend generally radially about the internal environment.

The apparatus may further include an outer gasket arranged compressed in a passage between the first and second flange elements. At least one of the first and second flange elements may include a first groove, and the outer gasket may be seated in the first groove. The first groove may be generally annular in shape, and may extend about the internal environment radially intermediate the purge gas channel and the external environment. The outer gasket may include a Kammprofile gasket.

The apparatus may further include an inner gasket arranged compressed in a passage between the first and second flange elements. At least one of the first and second flange elements may include a second groove, and the inner gasket may be seated in the second groove. The second groove may be generally annular in shape, and may extend about the internal environment radially intermediate the internal environment and the purge gas channel. The inner gasket may include a flexible refractory fiber gasket.

The first and second flange elements may be fastened together.

According to another aspect of the present disclosure, a purge gas distribution system may include: a pressurized gas source; at least one apparatus as described above in fluid communication with the pressurized gas source; at least one meter device arranged between the purge gas source and the at least one apparatus for monitoring the flow of purge gas to the at least one apparatus; and at least one control valve arranged between the purge gas source and the at least one apparatus.

The system may further include a first purge gas supply line and a second purge gas supply line connecting the purge gas source to the at least one apparatus. The at least one port may include a plurality of ports located spaced apart along the purge gas channel, and the plurality of ports may include at least one port in fluid communication with the first purge gas supply line, and at least one port in fluid communication with the second purge gas supply line. The second purge gas supply line may be configured to supply a higher flow rate of purge gas than the first purge gas supply line.

The at least one apparatus may include a plurality of the apparatuses, and each of the apparatuses may be connected to the purge gas source by the first and second gas supply lines. The apparatuses may be grouped in at least first and second groups, and flow of purge gas to the groups may be separately controllable by actuation of a plurality of the at least one control valve. Flow of purge gas through both the first and second purge gas supply lines may be separately controllable by actuation of the control valves. Flow of purge gas to each of the apparatuses in each of the groups may be separately controllable by actuation of the control valves.

According to another aspect of the present disclosure, a method of connecting first and second conduits may include: coupling a first flange element fixed to the first conduit and a second flange element fixed to the second conduit to permit fluid communication in an internal environment between the first and second conduits; and delivering a flow of purge gas between the first and second flange elements so that a pressure gradient of the flow of purge gas substantially prevents at least one of fluid egress from the internal environment and fluid ingress from an external environment.

The method may further include monitoring the flow and/or pressure of the purge gas. The method may further include: supplying purge gas from a pressurized gas source through a first supply line; and if a critical flow and/or pressure of the purge gas is detected, supplying purge gas from the pressurized gas source through a second supply line. The method may further include supplying purge gas through the second supply line at a higher flow rate than through the first supply line.

### BRIEF DESCRIPTION OF THE DRAWINGS

In order that the claimed subject matter may be more fully understood, reference will be made to the accompanying drawings, in which:

FIG. 1 is an exploded perspective view of a conduit connection apparatus;

FIG. 2 is another exploded perspective view of the apparatus of FIG. 1, shown in reverse angle;

FIG. 3 is a perspective view of the apparatus of FIG. 1, shown assembled;

FIG. 4 is a section view along line 4-4 in FIG. 3;

FIG. 5 is a schematic diagram of a purge gas distribution system;

FIG. 6 is a perspective view of another conduit connection apparatus, shown assembled;

FIG. 7 is a perspective view of a portion of the apparatus of FIG. 6, shown in reverse angle;

FIG. 8 is a schematic diagram of another purge gas distribution system; and

FIG. 9 is a schematic diagram of a further purge gas distribution system.

### DETAILED DESCRIPTION

In the following description, specific details are set out to provide examples of the claimed subject matter. However, the examples described below are not intended to define or limit the claimed subject matter. It will be apparent to those skilled in the art that many variations of the specific examples may be possible within the scope of the claimed subject matter.

For simplicity and clarity of illustration, where considered appropriate, reference numerals may be repeated among the drawings to indicate corresponding or analogous elements or steps.

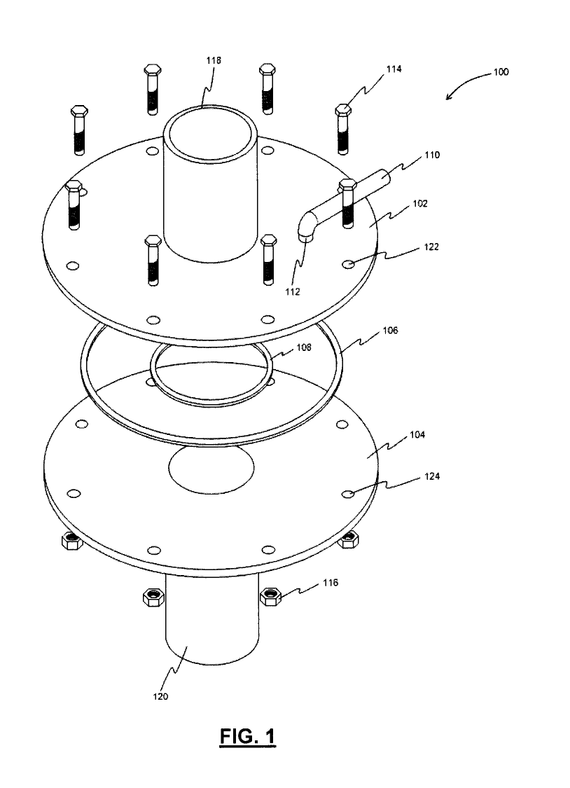

Referring to FIG. 1, an example of a conduit connection apparatus is shown generally at reference numeral 100. In the example illustrated, the apparatus 100 includes a first flange element 102, a second flange element 104, an outer gasket 106, an inner gasket 108, a purge gas supply line 110, a connection nipple 112, a plurality of bolts 114, and a plurality of nuts 116.

The first flange element 102 is welded or otherwise fixed to one end of a first conduit 118. The second flange element 104 is similarly fixed to one end of a second conduit 120. The conduits 118, 120 are shown to be generally cylindrical pipes, but in various examples may be any suitable structure configured to convey a flow of gas. A plurality of first holes 122 extends through the full thickness of the first flange element 102. A plurality of second holes 124, which are arranged in alignment with the first holes 122, extends through the full thickness of the second flange element 104. As shown in FIG. 1, an inner mating surface of the second flange element 104 may be generally planar.

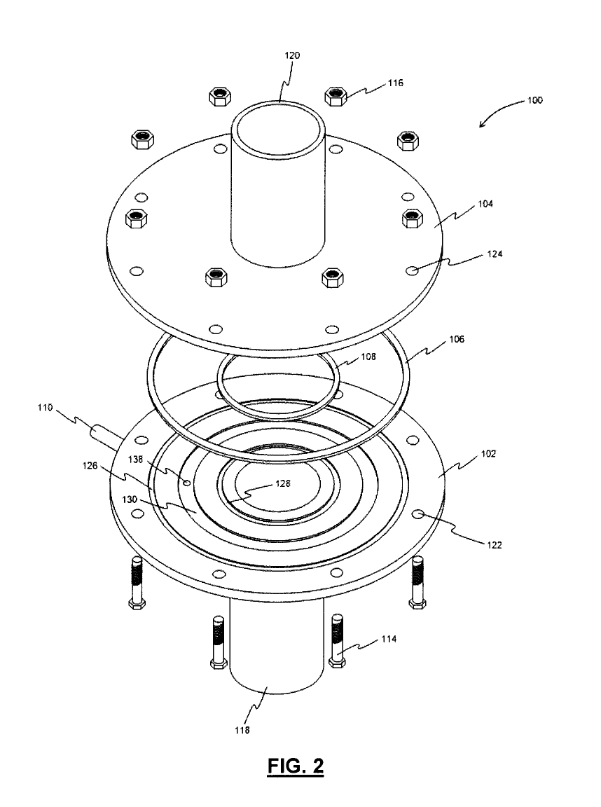

Referring to FIG. 2, an inner mating surface of the first flange element 102 may include a first or outer groove 126, and a second or inner groove 128, which are shown to be generally concentrically arranged. When the apparatus 100 is assembled, the gaskets 106, 108, which may be generally ring-shaped, are seated in the outer groove 126 and the inner groove 128, respectively.

A purge gas channel 130 is located generally between the outer groove 126 and the inner groove 128. Each of the outer groove 126, the inner groove 128, and the purge gas channel 130 may be an annular cutout extending through only a portion of the full thickness of the first flange element 102.

At least one port 138 is located within the purge gas channel 130. The port 138 establishes fluid communication between the supply line 110 and the purge gas channel 130, and may be, for example but not limited to, a hole extending through the full thickness of first flange element 102. In other examples, a separate line or tube with a port therein may be used to deliver purge gas within the purge gas channel 130.

In some examples, the supply line 110 may carry an inert gas, such as a noble gas, or nitrogen, so as to avoid reaction with the gas being conveyed by the conduits 118, 120. In other examples, the supply line 110 may carry air, which would not be suitable if the conduits 118, 120 are conveying carbon monoxide (as air would form an explosive mixture with carbon monoxide), but if, for example, the conduits 118, 120 are conveying a toxic but non-flammable gas (such as carbon dioxide), then air may be used. In various examples, the term purge gas may refer to a gas that is: non-reactive with a process gas conveyed by the conduits 118, 120, at any expected mixture concentration; non-combustible with the process gas, at any expected mixture concentration; and non-toxic.

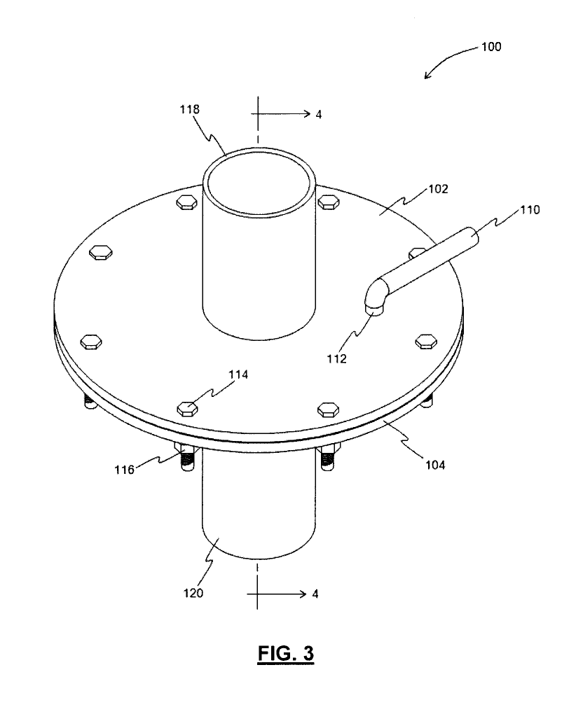

The apparatus 100 is shown assembled in FIG. 3. The first flange element 102 is coupled to the second flange element 104 by the bolts 114 and the nuts 116. Tightening the bolts 114 and the nuts 116 clamps the first flange element 102 and the second flange element 104 together. By adjusting the bolts 114 and the nuts 116, compressive stress at an interface between the first flange element 102 and the second flange element 104 may be varied. Although fasteners in the form of the bolts 114 and nuts 116 are illustrated, it should be appreciated that other means of coupling the flange elements 102, 104 together are possible.

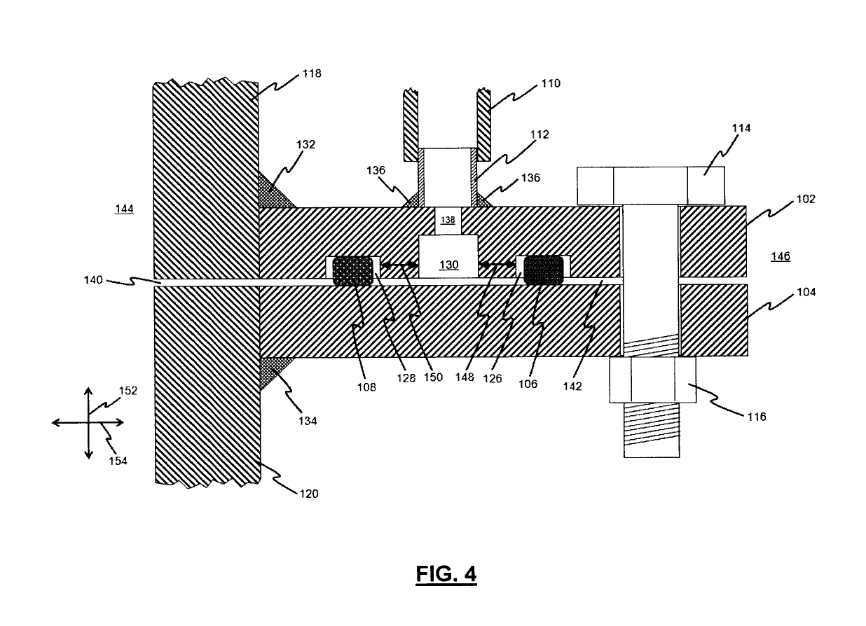

Now referring to FIG. 4, gas flows internally within the conduits 118, 120 in an internal environment 144 generally according to an axial direction 152. In the example illustrated, the outer gasket 106 seated in the outer groove 126 is intermediate of the purge gas channel 130 and an external environment 146 in a radial direction 154. Similarly, the inner gasket 108 seated in the inner groove 128 is intermediate of the internal environment 144 and the purge gas channel 130 in the radial direction 154.

The first flange element 102 and the second flange element 104 are shown fixed to the conduits 118, 120 by welds 132, 134, respectively. In other examples, different means of connection may be employed instead of welding, such as threaded, lap-joint, or slip-on connections. Furthermore, the connection nipple 112 is shown fixed to the first flange element 102 by a weld 136. In other examples, different means of connection, such as threaded connections, may be employed instead of the weld 136 to couple the connection nipple 112 to the first flange element 102.

In the example illustrated, the connection nipple 112 is a small pipe segment that facilitates attachment of the supply line 110 to the first flange element 102. The supply line 110 attaches to the connection nipple 112 by a press fit, threaded, welded, or other suitable connection, and permits a flow of purge gas to pass through the port 138 and into the purge gas channel 130.

As mentioned above, in the example illustrated, the first flange element 102 and the second flange element 104 are coupled together by tightening the bolts 114 and the nuts 116. The force produced by this clamping action compresses the outer gasket 106 and the inner gasket 108 within the outer groove 126 and the inner groove 128, respectively. The outer gasket 106 and the inner gasket 108 thereby deform and tend to fill voids of opposing mating surfaces within the grooves 126, 128. Given sufficient compression, the outer gasket 106 and the inner gasket 108 will effectively seal passages 140, 142 at the interface of the first flange element 102 and the second flange element 104, so that gas flowing internally within the conduits 118, 120 will not be able to pass from the internal environment 144 to the external environment 146, and vice versa.

In the example illustrated, depths of the grooves 126, 128 are less than thicknesses of the respective gaskets 106, 108 in order to ensure compression of the gaskets 106, 108. In other examples, the depths of the grooves 126, 128 may be zero (i.e. no grooves). Additionally, radial positions of the outer groove 126 and the inner groove 128 may vary depending on the particular example. The outer groove 126 may be positioned generally anywhere between the bolts 114 and the purge gas channel 130, including directly adjacent to the purge gas channel 130 (i.e. a dimension 148 in the radial direction 154 is equal to zero). The inner groove 128 may be positioned generally anywhere between the conduits 118, 120 and the purge gas channel 130, including directly adjacent to purge gas channel 130 (i.e. a dimension 150 in the radial direction 154 is equal to zero). Locating the inner groove 128 directly adjacent to the purge gas channel 130 may be desirable in high temperature applications, as purge gas within the purge gas channel 130 may cool the inner gasket 108 and protect it from damage due to the high temperature gas flowing within the internal environment 144.

With continued reference to FIG. 4, sealing action of the outer gasket 106 and inner gasket 108 will generally prevent purge gas within the purge gas channel 130 from flowing into either of the internal environment 144 or the external environment 146. However, it is recognized that the sealing action of any gasket may not be perfect, due to microscopic surface imperfections, gasket wear, and so on. If a leak develops, direction of gas flow between the internal environment 144, the purge gas channel 130, and the external environment 146 will depend on relative gas pressures within these zones.

In some examples, purge gas supplied to the purge gas channel 130 may have a pressure selected to be greater than pressures in the environments 144, 146, such that any leak will involve only purge gas flowing out of the purge gas channel 130 and into the internal environment 144 and/or the external environment 146. Accordingly, ingress of air from the external environment 146, or egress of process gas from the internal environment 144, would not be generally physically possible against the pressure gradient established by the greater gas pressure within the purge gas channel 130.

Furthermore, flow rate of gas out of the purge gas channel 130 and into the environments 144, 146 may be a function of the pressure gradient and the flow resistance between these zones. Flow resistance is the result of frictional fluid forces, and is generally dependent on the size and layout of the flow passages, among other variables. For a given pressure difference between two points, a higher flow resistance may result in a lower fluid flow rate between the same two points. When the passages 140, 142 are sufficiently sealed by the inner gasket 108 and the outer gasket 106, flow resistance between the purge gas channel 130 and the environments 144, 146 may be relatively high. Consequently, flow rate of gas out of the purge gas channel 130 and into the environments 144, 146 may be relatively low.

As the gaskets 106, 108 experience wear or damage, gaps and passages may develop that serve to decrease flow resistance between the purge gas channel 130 and the environments 144, 146. This may result in a higher out-leakage of purge gas from the purge gas channel 130 into the internal environment 144 and/or the external environment 146. Therefore, by measuring flow rate of purge gas being supplied to the purge gas channel 130, sealing effectiveness of the gaskets 106, 108 may be monitored. As described in further detail below, if a critical flow rate is detected, the apparatus 100 may be scheduled for maintenance in order to replace the outer gasket 106 and/or the inner gasket 108. Even at the critical flow rate, which may be indicative of significant gasket damage, escape of process gas from the internal environment 144 and infiltration of air from the external environment 146 may still be prevented, so long as purge gas channel 130 is maintained at a higher pressure than the environments 144, 146.

In some particular examples of the apparatus 100, which may be suitable for high temperature applications, a Kammprofile gasket may be implemented as the outer gasket 106, and a flexible refractory fiber gasket may be implemented as the inner gasket 108. In these examples, the Kammprofile gasket may provide relatively high seal integrity at high temperatures, with a sufficiently low seating stress to keep a size of the apparatus 100 reasonable. To ensure maximum compression, the Kammprofile gasket may be positioned as closely as possible to the bolts 114 and the nuts 116, where outward deflection of first flange element 102 and second flange element 104 is at a minimum.

However, using a Kammprofile gasket as the outer gasket 106 may interfere with compression of the inner gasket 108. Due to the nature of its construction, a Kammprofile gasket may exhibit a sharp increase in stiffness beyond its minimum seating stress, which may effectively prevent further compression of the inner gasket 108. Consequently, once the outer gasket 106 has been compressed to its seating stress, it may be practically impossible to achieve further compression of the inner gasket 108 by tightening the bolts 114 and the nuts 116. The compression of the inner gasket 108 at this point must therefore be sufficient to maintain a seal between the internal environment 144 and the purge gas channel 130. Furthermore, an exact thickness of the inner gasket 108 may be uncertain due to machining tolerances of the first flange element 102 and the second flange element 104. The inner gasket 108 may therefore be formed of a sufficiently flexible material to allow for a variable final thickness. For these reasons, as mentioned above, a flexible refractory fiber gasket may be suitable for use as the inner gasket 108. The tolerance requirements on this gasket type may be sufficiently wide so that an acceptable seal is achieved for a range of possible thicknesses.

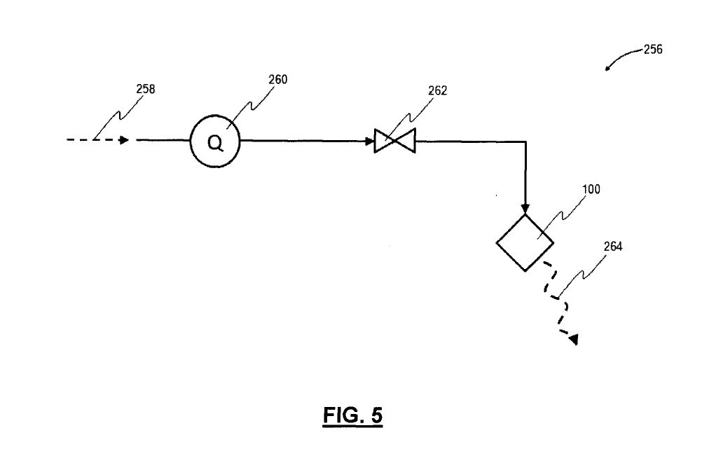

Referring now to FIG. 5, an example of a purge gas distribution system is shown generally at reference numeral 256. In the example illustrated, the system 256 includes a pressurized gas source 258, a flow meter device 260, a control valve 262, and the apparatus 100. The system 256 controls gas flow from the pressurized gas source 258 to the apparatus 100.

Initially, the apparatus 100 may be well-sealed and the control valve 262 may be set to a fully open position. Due to the sealing action of the apparatus 100, purge gas out-leakage 264 may be minimal, and the flow meter device 260 measures a relatively low flow rate. Over time, sealing effectiveness of the apparatus 100 may decrease due to gasket wear and other factors, which may increase the rate of purge gas out-leakage 264. This will result in a higher measured flow rate at the flow meter device 260. Sealing effectiveness of the apparatus 100 may therefore be determined by monitoring the flow meter device 260. At a critically high flow rate, for example, indicating an unacceptable level of gasket damage, the flow of purge gas may be shut off using the control valve 262, allowing for the replacement of damaged gaskets and/or other maintenance procedures. After repair and maintenance procedures are complete, the control valve 262 may be opened to resume the provision of purge gas from the pressurized gas source 258 to the apparatus 100.

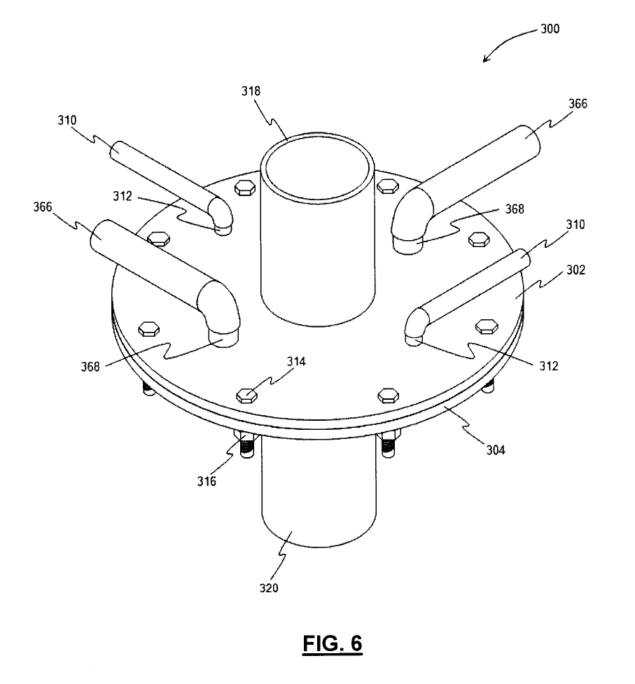

Referring now to FIG. 6, another example of a conduit connection apparatus is shown generally at reference numeral 300. In the example illustrated, the apparatus 300 includes a first flange element 302, a second flange element 304, a plurality of bolts 314, and a plurality of nuts 316. The first flange element 302 is welded or otherwise fixed to one end of a first conduit 318. The second flange element 304 is similarly fixed to one end of a second conduit 320. The apparatus 300 further includes at least one first supply line 310 and at least one second supply line 366, the operation of which is described in further detail below. The lines 310 connect to the first flange element 302 by connection nipples 312. Similarly, the lines 366 connect to the first flange element 302 by connection nipples 368.

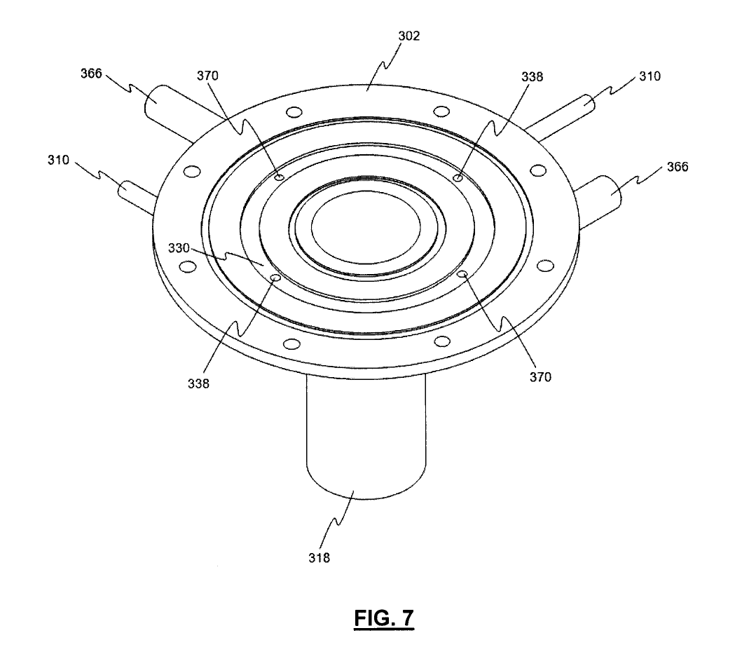

FIG. 7 shows a purge gas channel 330 of the first flange element 302 that contains ports 338 and ports 370. Each of the ports 338, 370 may be formed as a hole extending through the full thickness of first flange element 302. The ports 338, 370 establish fluid communication between the lines 310, 366 and the purge gas channel 330, respectively. Thus, in the apparatus 300, purge gas may be supplied through two locations or more within the purge gas channel 330 (versus a single location in the apparatus 100).

It should be appreciated that purge gas tends to undergo a continual pressure drop, due to friction, as it flows through a length of the purge gas channel. This pressure drop may become more significant as the length (i.e. diameter in the example illustrated) of the purge gas channel increases. By employing multiple purge gas ports, the total flow length of the purge gas within the purge gas channel may be reduced.

In the example illustrated, this may decrease pressure losses, and may result in a more uniform pressure distribution of purge gas throughout the purge gas channel 330 (which may be particularly beneficial for examples in which the conduits 318, 320 are relatively large diameter pipes). Consequently, the sealing effectiveness of the apparatus 300 may be improved.

With continued reference to FIG. 7, the number and positioning of the ports 338, 370 and their respective lines 310, 366 may be varied. In some examples, additional ports 338, 370 connected to the lines 310, 366, respectively, may be implemented. In other examples, a single port 338 in fluid communication with the line 310 and a single port 370 in fluid communication with the line 366 may be utilized. In other examples, a single one of the lines 310 and a single one of the lines 366 may each be arranged to feed multiple ports 338, 370. Finally, some examples may employ a different number of the ports 338 than the ports 370; for example, two of the ports 370 and one port 338. Various configurations of ports/lines are possible.

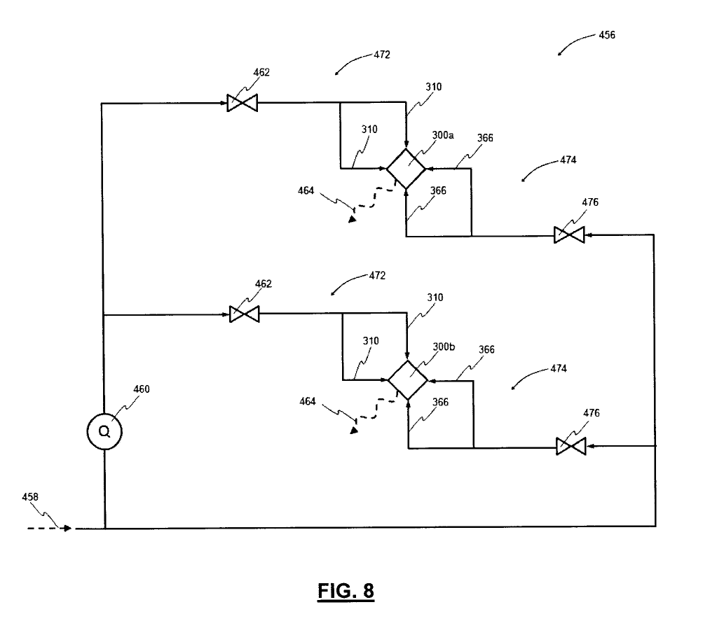

Referring now to FIG. 8, another example of a purge gas distribution system is shown generally at reference numeral 456. In the example illustrated, the system 456 includes two of the apparatus 300, denoted by reference numerals 300a and 300b. In other examples, additional ones of the apparatus 300 may be incorporated in the system 456, generally in the same manner.

Each of the apparatuses 300a, 300b has a primary side 472 and a secondary side 474. In the primary side 472, a control valve 462 is arranged connected to the lines 310. A flow meter device 460 is connected upstream on the primary side 472, such that it measures the combined flow rate and/or pressure of the purge gas being supplied to the apparatuses 300a, 300b. In the secondary side 474, a control valve 476 is arranged connected to the lines 366. A pressurized gas source 458 supplies purge gas to the system 456.

Flow of purge gas to the apparatuses 300a, 300b is separately controllable by actuation of the control valves 462, 476. During initial operation, the control valves 462 may be fully open to allow the flow of purge gas to the apparatuses 300a, 300b through the primary side 472. At this time, the control valves 476 may be fully closed. Both of the apparatuses 300a, 300b may be initially well-sealed, so that there is a relatively low purge gas out-leakage 464. The flow meter device 460 will therefore output a nominally low flow rate.

Over time, the sealing effectiveness of the apparatuses 300a, 300b may decrease, e.g., due to gasket wear, and the measured flow rate at the flow meter device 460 will increase correspondingly. At a critically high flow rate, at which point repair and maintenance are deemed necessary, identification of which one of the apparatuses 300a, 300b is leaking may be carried out. To determine which one of the apparatuses 300a, 300b is leaking, the control valve 462 leading to the apparatus 300a may first be closed while observing the resulting change in the output of the flow meter device 460; a significant reduction indicates a leak in the apparatus 300a. The control valve 462 leading to the apparatus 300a may then be reopened, and the procedure repeated for the control valve 462 leading to the apparatus 300b; a significant reduction in the output of the flow meter device 460 indicates a leak in the apparatus 300b. Through this process, it may be determined which one of the apparatuses 300a, 300b is leaking.

If a leak is detected in the apparatus 300a, the control valve 462 leading to the apparatus 300a may be closed and the control valve 476 leading to the apparatus 300a on the secondary side 474 may be opened. This allows purge gas to flow to the apparatus via the secondary side 474 instead of the primary side 472. Since the apparatus 300b is still relatively well-sealed, the output of the flow meter device 460 will return to a nominally low value. Thus, the supply of purge gas has been maintained at the apparatus 300a, and the flow meter device 460 has been “tared” such that subsequent leaks from the apparatus 300b may still be detected. The flow of purge gas to the apparatus 300a may be maintained by the secondary side 474, until the apparatus 300a is isolated (e.g., by closing both of the control valves 462, 476 leading to the apparatus 300a) and repaired. Following repair procedures, the flow of purge gas to the apparatus 300a via the primary side 472 may be resumed. Alternatively, if a leak is detected in the apparatus 300b, the above procedure may be repeated, but by actuating the control valves 462, 476 leading to the apparatus 300b instead.

The flow of purge gas to the apparatuses 300a, 300b in cases of a leak is required to be significantly higher than the flow to the apparatuses 300a, 300b that are well-sealed. Consequently, the secondary side 474 may be configured to supply a higher flow rate of purge gas. For example, larger diameter pipes may be utilized on the secondary side 474 as compared to the primary side 472. FIGS. 6 and 7 show the lines 310 (and the connection nipples 312) to be of smaller diameter than the lines 366 (and the connection nipples 368). This may provide several advantages, including: capital cost savings by employing smaller and therefore less expensive piping in the primary side 472; reduced flow through smaller diameter pipes in the primary side 472 may reduce purge gas consumption and therefore operational expenses; reduced pressure losses in larger diameter pipes in the secondary side 474 may result in higher gas flow at the apparatuses 300a, 300b, which may improve the sealing effectiveness; and reduced sound levels in the secondary side 474 due to lower flow velocities.

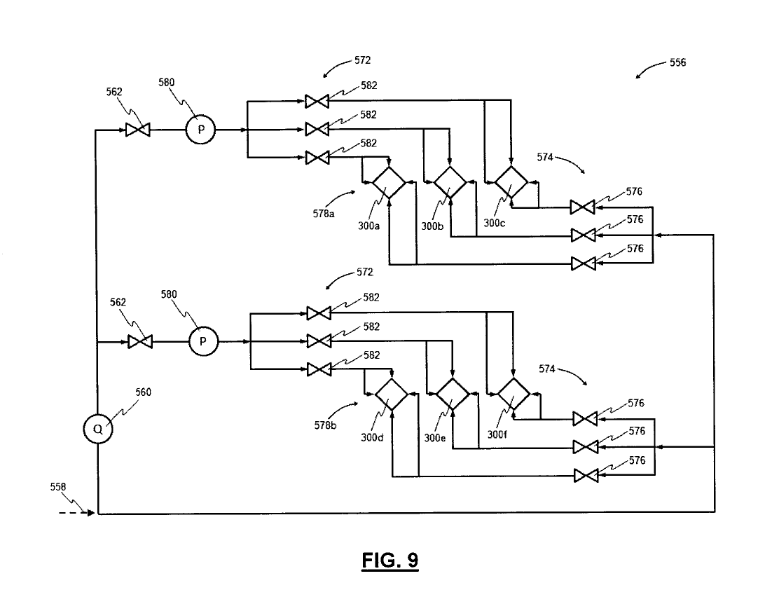

Referring now to FIG. 9, another example of a purge gas distribution system is shown generally at reference numeral 556. In the example illustrated, a first group 578a and a second group 578b are shown. Each of the groups 578a, 578b consists of three of the apparatuses 300, denoted by reference numerals 300a, 300b, 300c and 300d, 300e, 300f, respectively. Each of the groups 578a, 578b has a primary side 572 and a secondary side 574. In the primary side 572, control valves 562 and pressure meter devices 580 are arranged connected upstream of the apparatuses 300a, 300b, 300c, 300d, 300e, 300f. A flow meter device 560 is arranged connected upstream of the control valves 562. Further control valves 582 are arranged connected upstream of each of the apparatuses 300a, 300b, 300c, 300d, 300e, 300f. In the secondary side 574, immediately upstream of the apparatuses 300, further control valves 576 are arranged connected to each of the apparatuses 300 individually. A pressurized gas source 558 supplies purge gas to the system 556.

During initial operation, each the groups 578a, 578b is supplied with purge gas through the primary side 572. Initially, the flow meter device 560 will output a nominally low flow rate and/or pressure. Purge gas out-leakage at one or more of the apparatuses 300a, 300b, 300c, 300d, 300e, 300f will be indicated by an increase in the output of the flow meter device 560.

The method employed to determine the leakage location is similar to the previous example described with respect to FIG. 8. The control valves 562, in conjunction with the flow meter device 560, may be employed to determine which of the groups 578a, 578b contains one of the apparatuses 300a, 300b, 300c, 300d, 300e, 300f that is leaking. The control valves 582, in conjunction with pressure meter devices 580, may then be employed to determine which one of the apparatuses 300a, 300b, 300c, 300d, 300e, 300f is leaking.

The control valve 582 corresponding to the leaking one of the apparatuses 300a, 300b, 300c, 300d, 300e, 300f may be closed, and the corresponding control valve 576 may be opened. This ensures the continued flow of purge gas to the one of the apparatuses 300a, 300b, 300c, 300d, 300e, 300f that is leaking via the secondary side 574, and tares the primary side 572 of the remaining ones of the apparatuses 300a, 300b, 300c, 300d, 300e, 300f.

In the example illustrated in FIG. 9, the pressure meter devices 580 are implemented. In contrast to flow meters, pressure meters may show a significant increase in output when flow to the one of the apparatuses 300a, 300b, 300c, 300d, 300e, 300f that is leaking is stopped. Furthermore, pressure meters may be generally less expensive than flow meters. In a large facility employing many conduit connection apparatuses, there may be strong economic incentive to employ the lowest cost components for the purge gas distribution system. In the system 556, the pressure meters 580 may be replaced with flow meters while maintaining the same functionality, but generally at a higher cost.

Finally, it should be appreciated that the configuration shown in FIG. 9 may allow for efficient determination of which one of the apparatuses 300a, 300b, 300c, 300d, 300e, 300f is leaking. By grouping the apparatuses 300a, 300b, 300c, 300d, 300e, 300f in the groups 578a, 578b, the number of valves that must be actuated to ascertain the leakage location may be reduced.

It will be appreciated by those skilled in the art that many variations are possible within the scope of the claimed subject matter. The examples that have been described above are intended to be illustrative and not defining or limiting.

1-17. (canceled)

18. A purge gas distribution system wherein a pressure gradient of the flow of purge gas substantially prevents at least one of fluid egress from the internal environment and fluid ingress from an external environment, comprising:
at least one connecting apparatus for connecting first and second conduits, having a first flange element fixed to the first conduit, a second flange element fixed to the second conduit, the second flange element coupled to the first flange element to permit fluid communication in an internal environment between the first and second conduits, and at least one port that communicates intermediate the first and second flange elements to deliver a flow of purge gas therebetween;
the connecting apparatus also having a purge gas channel arranged between mating surfaces of the first and second flange elements, communicating with the at least one port;
the connecting apparatus also having at least one of a Kammprofile outer gasket or a flexible refractory fiber inner gasket arranged compressed in a passage between the first and second flange elements;
a pressurized gas source in fluid communication with the connecting apparatus;
at least one meter device arranged between the purge gas source and the at least one apparatus for monitoring the flow of purge gas to the at least one apparatus; and
at least one control valve arranged between the purge gas source and the at least one apparatus.

19. The system of claim 33, further comprising a first purge gas supply line and a second purge gas supply line connecting the purge gas source to the at least one apparatus.

20. The system of claim 19, wherein the at least one port comprises a plurality of ports located spaced apart along the purge gas channel, and the plurality of ports comprises at least one port in fluid communication with the first purge gas supply line, and at least one port in fluid communication with the second purge gas supply line.

21. The system of claim 20, wherein the second purge gas supply line is configured to supply a higher flow rate of purge gas than the first purge gas supply line.

22. The system of claim 21, wherein the at least one apparatus comprises a plurality of the apparatuses, and each of the apparatuses is connected to the purge gas source by the first and second gas supply lines.

23. The system of claim 22, wherein the apparatuses are grouped in at least first and second groups, and flow of purge gas to the groups is separately controllable by actuation of a plurality of the at least one control valve.

24. The system of claim 23, wherein flow of purge gas through both the first and second purge gas supply lines is separately controllable by actuation of the control valves.

25. The system of claim 24, wherein flow of purge gas to each of the apparatuses in each of the groups is separately controllable by actuation of the control valves.

26. A method of connecting first and second conduits, comprising:
coupling a first flange element fixed to the first conduit and a second flange element fixed to the second conduit to permit fluid communication in an internal environment between the first and second conduits; and
delivering a flow of purge gas between the first and second flange elements so that a pressure gradient of the flow of purge gas substantially prevents at least one of fluid egress from the internal environment and fluid ingress from an external environment;
wherein at least one connecting apparatus is used for connecting the first and second conduits, the connecting apparatus having a first flange element fixed to the first conduit and a second flange element fixed to the second conduit, with the second flange element being coupled to the first flange element to permit fluid communication in an internal environment between the first and second conduits, and at least one port that communicates intermediate the first and second flange elements to deliver a flow of purge gas therebetween;
the connecting apparatus also having a purge gas channel arranged between mating surfaces of the first and second flange elements, communicating with the at least one port;
the connecting apparatus also having at least one of a Kammprofile outer gasket or a flexible refractory fiber inner gasket arranged compressed in a passage between the first and second flange elements.

27. The method of claim 36, further comprising monitoring the flow and/or pressure of the purge gas.

28. The method of claim 27, further comprising:
supplying purge gas from a pressurized gas source through a first supply line; and
if a critical flow and/or pressure of the purge gas is detected, supplying purge gas from the pressurized gas source through a second supply line.

29. The method of claim 28, further comprising supplying purge gas through the second supply line at a higher flow rate than through the first supply line.

30. (canceled)

31. The purge gas distribution system of claim 18 wherein the apparatus has a Kammprofile outer gasket arranged compressed in a passage between the first and second flange elements, the outer gasket being generally annular in shape and extending about the internal environment radially intermediate the purge gas channel and the external environment.

32. The purge gas distribution system of claim 18 wherein the apparatus has a flexible refractory fiber inner gasket arranged compressed in a passage between the first and second flange elements, the inner gasket being generally annular in shape and extending about the internal environment radially intermediate the internal environment and the purge gas channel and the external environment.

33. The purge gas distribution system of claim 31 wherein the apparatus has a flexible refractory fiber inner gasket arranged compressed in a passage between the first and second flange elements, the inner gasket being generally annular in shape and extending about the internal environment radially intermediate the internal environment and the purge gas channel and the external environment.

34. The method of claim 26 wherein the apparatus has a Kammprofile outer gasket arranged compressed in a passage between the first and second flange elements, the outer gasket being generally annular in shape and extending about the internal environment radially intermediate the purge gas channel and the external environment.

35. The method of claim 26 wherein the apparatus has a flexible refractory fiber inner gasket arranged compressed in a passage between the first and second flange elements, the inner gasket being generally annular in shape and extending about the internal environment radially intermediate the internal environment and the purge gas channel and the external environment.

36. The method of claim 34 wherein the apparatus has a flexible refractory fiber inner gasket arranged compressed in a passage between the first and second flange elements, the inner gasket being generally annular in shape and extending about the internal environment radially intermediate the internal environment and the purge gas channel and the external environment.
